(19) United States
(12) Patent Application Publication
(10) Pub. No.: US 2010/0093575 A1
(43) Pub. Date: Apr. 15, 2010

(54) GRAFT COPOLYMER

(76) Inventor: Patric Meessen, La Calamine (BE)

Correspondence Address: NIXON & VANDERHYE, PC, 901 NORTH GLEBE ROAD, 11TH FLOOR, ARLINGTON, VA, 22203, US

(21) Appl. No.: 12/527,284

(22) PCT Filed: Feb. 18, 2008
(86) PCT No.: PCT/EP2008/001227

§ 371 Date: Nov. 12, 2009

(30) Foreign Application Priority Data
Feb. 20, 2007 (EP) 07003471.5

(51) Int. Cl. C08F 255/04; C10M 107/22

(52) U.S. Cl. 508/306; 525/207

(57) ABSTRACT

The invention relates to a graft copolymer comprising the reaction product of maleic anhydride and a backbone polymer wherein said graft copolymer comprises between 0.50 and 5.0 weight percent of maleic anhydride, wherein said backbone polymer is selected from the group consisting of poly-olefins and copolymers of ethylene and α-olefins with 3 to 8 carbon atoms, the graft copolymer has a MFI of more than 50 dg/min (@190° C., 2.16 kg), and more than 25% of the graft copolymer chains have a chain-end unsaturation. These graft copolymers are suitable as processing aids in e.g. extrusion of high molecular weight polymers. The invention relater also to a method for grafting maleic anhydride to polymers, comprising the steps of: melting an ethylene polymer by heating and down-shearing the polymer in a co- rotating, twin-screw extruder while injecting maleic anhydride and a free radical initiator into a polymer filled, pressurized section of the extruder; and mixing the polymer and the maleic anhydride in the extruder for sufficient time to graft the maleic anhydride wherein the free radical initiator is an organic peroxide that has a half-life (t_{1/2}) of more than 1 second if measured in mono-chlorobenzene at 240° C.

The invention relates to a graft copolymer comprising the reaction product of maleic anhydride and a backbone polymer wherein between 0.50 and 4.0 weight percent of said graft copolymer comprises maleic anhydride, wherein said backbone polymer is selected from the group consisting of poly-olefins, and copolymers of ethylene and α-olefins with 3 to 8 carbon atoms and the copolymer has a MFI of more than 50 dg/min measured at 190° C. and 2.16 kg.

Such a graft copolymer is e.g. known from U.S. Pat. No. 5,075,383 as intermediate product in a method for producing imidized copolymers for oil lubricants. Graft copolymers with a MFI as described above may also be applied as processing aid in a mixture with a high molecular weight polymer.

A disadvantage of the known grafted copolymers as a processing aid is that they tend to migrate to the surface of a part made from a high molecular weight polymer and its processing aid.

A purpose of the present invention is to provide a grafted copolymer that can be bonded to a polymer with which it is mixed, thus presenting a lower tendency to migrate to the surface.

This problem is solved in that more than 25% of the graft copolymer chains have a chain-end unsaturation.

Graft copolymers with a chain-end unsaturation of more than 25% can easily be bonded to a high molecular weight polymers by chemical crosslinking via the chain-end unsaturation. An advantage of the graft copolymers of the invention is that coupling to a high molecular weight polymer does not decrease the amount of maleic anhydride groups available for other functionalities.

Chain-end unsaturation in this invention is defined as the total number of vinyl, vinylidene, isobutenyl, and cis-2-butenyl groups per copolymer chain as measured by NMR. Vinyl-chain ends are generally accepted to be more reactive to chain-end functionalization and insertion in subsequent polymerization reactions than saturated chain ends. Alternatively the beta-hydrogen containing butenyl unsaturations are more reactive for sulfur vulcanization processes. A combination of end-chain unsaturations is thus preferred.

The graft copolymer according to the invention is a particular interesting processing aid in the processing of EPDM with a high molecular weight, as the graft copolymer is bonded to the EPDM via the chain-end unsaturations during sulfur curing of the EPDM.

The graft copolymer according to the invention can also be used as an intermediate product in the manufacturing of VI improvers, dispersants and anti-oxidants oil additives and oil compositions containing the same.

The invention further relates to a method for grafting maleic anhydride to copolymers, comprising the steps of: melting an ethylene polymer by heating and down-shearing the polymer in a co-rotating, twin-screw extruder while injecting maleic anhydride and a free radical initiator into a polymer filled, pressurized section of the extruder; and mixing the polymer and the maleic anhydride in the extruder for sufficient time to graft the maleic anhydride. Such a method is e.g. known from U.S. Pat. No. 4,762,890.

U.S. Pat. No. 4,762,890 describes a method for grafting maleic anhydride to polymers, comprising the steps of melting a polymer by heating and shearing the polymer in a co-rotating, twin-screw extruder, injecting maleic anhydride and a free radical initiator into a polymer filled, pressurized section of the extruder, and mixing the polymer and the maleic anhydride in the extruder for sufficient time to graft the maleic anhydride to the polymer. The maleic anhydride and the free radical initiator are preferably mixed in a solvent system prior to injection into the extruder. Devolatilization of the grafted polymer preferably occurs in one or more decompression sections of the extruder.

A problem is that the known method does not ends up in a product that combines a high MFI with an amount of maleic anhydride and an amount of chain-end unsaturations of more than 25%.

This problem is solved according to the invention in that the free radical initiator is an organic peroxide that has a half-live (t_{1/2}) of more than 1 second if measured in mono-chlorobenzene at 240° C.

Organic peroxides that have a half-life (t_{1/2}) of more than 1 second if measured in mono-chlorobenzene at 240° C. are e.g. 3,3,5,7,7-pentamethyl 1,2,4-trioxepane and 3,6,9-triethyl-3,6,9-trimethyl-1,4,7-triperoxonane as commercially available under the trade names Trigonox 311 and Trigonox 301 respectively.

Organic hydroperoxides that have a half-life (t_{1/2}) of more than 1 second if measured in mono-chlorobenzene at 240° C. are for example diisopropylbenzene monohydroperoxide, cumyl hydroperoxide and t-butylhydroperoxide as commercially available under the trade names Trigonox M, Trigonox K and Trigonox A respectively.

With an organic peroxide or hydroperoxide that has a half-life (t_{1/2}) of more than 1 second if measured in mono-chlorobenzene at 240° C., it is possible to obtain a downsheared and grafted copolymer with a MFI of more than 50 dg/min, between 0.50 and 4.0 weight percent of maleic anhydride and a chain-end unsaturation of more than 25%.

By injecting a first half of the total amount of the maleic anhydride and the organic peroxide in a first reaction zone at a temperature of between 250 and 290° C. and injecting a second half of the total amount of the maleic anhydride and the organic peroxide in a second reaction zone at a temperature of between 250 and 320° C., a chain-end unsaturation of between 50 and 100% can be obtained.

Maleic anhydride is preferably dosed in its pure form as a melt or alternatively as a room temperature solution in a solvent such as acetone. The peroxide is preferentially handled as a solution in a high purity mineral oil but might as well be dosed in its pure form or as solutions in low boiling solvents.

The invention further relates to a rubber part comprising the graft copolymer according to the invention. An advantage of a part comprising the graft copolymer according to the invention, mixed and cured onto a high molecular weight polymer is, that they can be processed at a high speed, but do not suffer from migration of the graft copolymer to the surface of the part and still have good mechanical properties.

Used hardware

| | |
|---|---|
| Co-rotating twin screw-extruder: | ZSK4048D |
| Equipped with: | |
| melting section | |
| first reaction zone | |
| second reaction zone | |
| Vacuum zone | |
| Rubber feeder: | K-tron S210 |
| MZA injection: | 2x injection unit |
| Peroxide injection: | 2x injection unit |

### EXAMPLES

Example 1

The grafting and down shearing process takes place simultaneously, in both reaction zones. Keltan 3200A (commercial EPM grade of DSM with an Mn of 76 kg/mol) was dosed into the extruder by using a grinder-feeder combination. When the EPM passes the melting zone, the melt temperature has been installed around 265° C. by adequate screw speed and design to start the down shearing and grafting process in the first reaction zone. At this zone 1.35 wt % MAH and 0.25 wt % Trigonox 311 have been added, by injection, into the melt. At the second reaction zone 1.35 wt % MAH and 0.25 wt % Trigonox 311 has been injected again. The melt temperature at the beginning of the second reaction zone was 300° C. In a last step, the melt is exposed to a vacuum to remove remaining peroxide decomposition products as well as unreacted maleic anhydride. Mn of the resulting polymer (Polymer I) was 20 kg/mol. The MFI (@190° C., 2.16 kg) was 200 dg/min. The maleic anhydride level grafted onto the polymer of 2.0 wt % was quantified by IR.

### Comparative Example A

The comparative Polymer A was made according to the following procedure. The base polymer was obtained via a Ziegler-Natta polymerization process copolymerizing ethylene and propylene. This copolymer with a molecular weight of 15 kg/mol and an ethylene level of 48 wt % was dissolved as a 68 wt % solution in hexane isomer mixture and heated under nitrogen in a pressurized vessel to 170° C. With 15 minutes interval two times 1.35 wt % maleic anhydride and 0.4 wt % of dicumyl peroxide have been added to the reactor under vigorous stirring. The polymer was isolated from the cooled solution by vacuum evaporation of the hexanes and reaction residues, resulting in a maleic anhydride grafted copolymer (Polymer A) with 2.0 wt % maleic anhydride and a molecular weight of 16 kg/mol.

### NMR Determination of Unsaturations

1H spectra were recorded on the Bruker DRX500 NMR spectrometer. The samples were dissolved in C₂D₂Cl₄ at 100° C.

Polymer I and polymer A were subjected to a NMR measurement in order to determine the amount of chain-end unsaturations.

In Polymer I various signals from unsaturations are observed. In Polymer A, very low levels of unsaturations on the detection limit of the method are seen; Table 1 gives an overview of the unsaturations found.

TABLE 1
Number of groups per 100.000 C copolymer chain atoms.

| | | Comparative |
|---|---|---|
| Group | Polymer I | polymer A |
| vinyl | 10 | <2 |
| vinylidene | 23 | 1 a 2 |
| isobutenyl | 40 | 2-3 |
| cis-2-butenyl | 20 | 1 a 2 |

It should be noted that all examples given in U.S. Pat. No. 5,078,353 with a low viscosity (MFI of more than 50 dg/min) are grafted in a solvent (e.g. comparative polymer A), which means that all the intermediate maleic anhydride grafted copolymers mentioned in U.S. Pat. No. 5,075,383 have a chain-end unsaturation of far below 25%.

The only Example in U.S. Pat. No. 5,078,353 wherein the grafting has taken place in an extruder is Example II. The viscosity of the end product is 23.008 cSt, which corresponds to a molecular weight of about 45 kg/mol and an MFI of about 3 dg/min (190° C., 2.16 kg).

Example 2

A similar experiment as described under example 1 was repeated but applying cumyl hydroperoxide as the free radical initiator. The temperature profile in the reaction zone was 275 and 309° C. at the 2 metering points respectively. The stoichiometry of the grafting chemicals as well as vacuum conditions were kept identical. The recovered polymer (Polymer II) was 14 kg/mol. The MFI (@190° C., 2.16 kg) was 360 dg/min. The maleic anhydride level grafted onto the polymer of 1.0 wt % was quantified by IR. Though the grafting efficiency is low compared to Polymer I, Polymer II is part of the scope of the present invention. The low grafting efficiency can easily be explained by a lower active radical efficiency due to the hydroperoxide character of the free radical initiator. The number of unsaturations per 100.000 C atoms was 113.

### Comparative Example B

The polymer and grafting and down-shearing equipment as for example 1 was used with an adjustment of the melt temperature reached under stable process conditions to suit the decomposition window of the peroxide 2,5-dimethyl-hex-3-yne-2,5- bis-tertiary-butyl peroxide as described in U.S. Pat. No. 5,078,353. At a reduced screw speed a melt temperature at the beginning of the second reaction zone of 211° C. was measured. Degassing of unreacted product was done via a vacuum zone. Final compression of the melt in the extruder head gave a final melt temperature 298° C.

The obtained maleic anhydride grafted polymer was a clear light yellow polymer with a melt flow index (MFI) of 4.8 dg/min (190° C., 2160 g), a gel level of 0.06 wt % and a maleic anhydride functional level measured by IR method of 1.95 wt %. The number of unsaturation per 100.000 C atoms was 35.

### Comparative Example C

The work as described under experiment 1 was repeated but applying 2,5-dimethyl-hex-3-yne-2,5- bis-tertiary-butyl peroxide as disclosed in U.S. Pat. No. 5,078,353 as the free radical initiator. The temperature profile as well as the stoichiometry was kept identical, resulting in a polymer with a MFI (@190° C., 2.16 kg) of 36 dg/min. The maleic anhydride level grafted onto the polymer of 0.6 wt % was quantified by IR. Clearly such an inefficient grafting yield and a too low MFI fall out of the scope of the present invention.

1. A graft copolymer comprising the reaction product of maleic anhydride and a backbone polymer wherein said graft copolymer comprises between 0.50 and 5.0 weight percent of maleic anhydride, wherein said backbone polymer is selected from the group consisting of copolymers of ethylene and α-olefins with 3 to 8 carbon atoms and the graft copolymer has a MFI of more than 50 dg/min (@190° C., 2.16 kg), characterized in that more than 25% of the graft copolymer chains have a chain-end unsaturation

2. The graft Copolymer according to claim 1, wherein the level of chain end unsaturated chains is between 50 and 100%.

3. The graft copolymer according to claim 1, wherein the backbone polymer is a copolymer of ethylene and propylene.

4. The graft copolymer according to claim 3, wherein ethylene and propylene are present in amounts of between 20-80 weight % 80-20 weight % respectively.

5. The graft copolymer of claim 1, wherein the MFI is more than 100 dg/min (@190° C., 2.16 kg).

6. A method for grafting maleic anhydride to copolymers, comprising the steps of: melting a copolymer of ethylene and α-olefins with 3 to 8 carbon atoms by heating and down-shearing the polymer in a co-rotating, twin-screw extruder while injecting maleic anhydride and a free radical initiator into a polymer filled, pressurized section of the extruder; and mixing the polymer and the maleic anhydride in the extruder for sufficient time to graft the maleic anhydride characterized in that the free radical initiator is an organic peroxide that has a half-life (tyₐ) of more than 1 second if measured in mono-chlorobenzene at 240° C.

7. The method of claim 6, wherein the organic peroxide is 3,3,5,7,7-pentamethyl 1,2,4-trioxepane or 3,6,9-triethyl-3,6,9-trimethyl-1,4,7-triperoxonane.

8. A rubber part comprising the graft copolymer according to claim 1.

9. An oil solution comprising the graft copolymer according to claim 1 as an additive or intermediate of an additive.
